(19) United States
(12) Patent Application Publication
(10) Pub. No.: US 2026/0018178 A1
(43) Pub. Date: Jan. 15, 2026

(54) SIGNAL PROCESSING DEVICE AND SIGNAL PROCESSING METHOD

(71) Applicant: Panasonic Intellectual Property Corporation of America, Torrance, CA (US)

(72) Inventors: Akira HARADA, Kanagawa (JP); Hiroyuki EHARA, Kanagawa (JP)

(73) Assignee: Panasonic Intellectual Property Corporation of America, Torrance, CA (US)

(21) Appl. No.: 19/108,579

(22) PCT Filed: Aug. 17, 2023
(86) PCT No.: PCT/JP2023/029675

§ 371 Date: Mar. 4, 2025

(30) Foreign Application Priority Data
Sep. 8, 2022 (JP) 2022-142899

(51) Int. Cl. G10L 19/008; G10L 21/043; G10L 25/18; H04S 1/00; H04S 7/00

(52) U.S. Cl. CPC G10L 19/008; G10L 21/043; G10L 25/18; H04S 1/007; H04S 7/30; H04S 2420/03

(57) ABSTRACT

This signal processing device comprises: a control circuit that, in accordance with a parameter relating to a stereo signal, alters a weighting coefficient based on the amplitude of the cross spectrum of the stereo signal; and a detection circuit that detects the inter-channel time difference of the stereo signal on the basis of the cross spectrum weighted using the weighting coefficient.

### TECHNICAL FIELD

The present disclosure relates to a signal processing apparatus and a signal processing method.

### BACKGROUND ART

There is an encoding technique for a stereo speech audio signal (hereinafter may also be referred to as a stereo signal), for example (see, e.g., Patent Literature (hereinafter, referred to as “PTL”) 1).

### CITATION LIST

### Patent Literature

PTL 1

Japanese Patent Application Laid Open No. 2020-60788

### Non-Patent Literature

NPL 1

Charles H. Knapp and G. Clifford Carter, “The Generalized Correlation Method for Estimation of Time Delay,” IEEE Trans. on Acoustics, Speech, and Signal Processing, vol. ASSP-24, no. 4, pp. 320-327, 1976

### SUMMARY OF INVENTION

In the encoding of a stereo signal, there is room for consideration regarding an estimation method for estimating an inter-channel time difference (ITD).

A non-limiting embodiment of the present disclosure contributes to providing a signal processing apparatus and a signal processing method capable of improving ITD estimation performance in encoding of a stereo signal.

A signal processing apparatus according to one exemplary embodiment of the present disclosure includes: control circuitry, which, in operation, alters a weighting coefficient in accordance with a parameter related to a stereo signal, the weighting coefficient being based on an amplitude of a cross spectrum of the stereo signal; and detection circuitry, which, in operation, detects an inter-channel time difference of the stereo signal based on the cross spectrum weighted with the weighting coefficient.

It should be noted that general or specific embodiments may be implemented as a system, an apparatus, a method, an integrated circuit, a computer program, a storage medium, or any selective combination thereof.

According to an embodiment of the present disclosure, it is possible to improve the ITD estimation performance in the encoding of a stereo signal.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of a transmission system for a speech audio signal;

FIG. 2 is a block diagram illustrating an exemplary configuration of an ITD analysis encoder;

FIG. 3 is a flowchart illustrating an example of ITD analysis encoding processing;

FIG. 4 is a block diagram illustrating an exemplary configuration of an ITD analysis encoder;

FIG. 5 is a flowchart illustrating an example of ITD analysis encoding processing;

FIG. 6 is a block diagram illustrating an exemplary configuration of an ITD analysis encoder;

FIG. 7 is a flowchart illustrating an example of ITD analysis encoding processing; and

FIG. 8 is a flowchart illustrating an example of ITD analysis encoding processing.

### DESCRIPTION OF EMBODIMENTS

Hereinafter, embodiments of the present disclosure will be described in detail with reference to the accompanying drawings.

One of the encoding methods for a stereo signal is a method of parameterizing the stereo signal by an inter-channel time difference (ITD) with respect to a stereo signal including an L channel (Left channel or L-ch) and an R channel (Right channel or R-ch).

The inter-channel time difference (ITD) of a stereo signal is a parameter related to a difference in time of arrival of a sound between the L channel and the R channel. For example, in the estimation (or detection) of ITD, a cross spectrum is calculated based on the Fast Fourier Transform (FFT) spectra of a pair of channel signals included in a stereo signal. Then, the ITD is estimated based on a time lag with respect to a peak position of inter-channel cross correlation (ICC) in the time domain obtained by performing an Inverse Fast Fourier Transform (IFFT) on the cross spectrum.

One method for estimating ITD is the generalized cross-correlation phase transform (GCC-PHAT) method (see, for example, NPL 1). Note that the GCC-PHAT method is also referred to as the CSP (cross-power spectrum phase analysis) method.

In the GCC-PHAT method, for example, weighting is performed, with the reciprocal of the amplitude of the cross spectrum, on the cross spectrum calculated from the FFT spectra of a pair of channel signals included in a stereo signal. In the GCC-PHAT method, ITD is estimated based on the time lag at the peak position of the inter-channel cross correlation (ICC) in the time domain, which is obtained by IFFT on the weighted cross spectrum.

The ITD estimation using the GCC-PHAT method is characterized by whitening of the cross spectrum by weighting the cross spectrum with the reciprocal of the cross spectrum amplitude, and the ITD is estimated by utilizing a phase component (for example, phase information) of the cross spectrum.

Here, for example, the stereo signal may include many frequency components with zero amplitude. Examples of a case where the stereo signal includes a large number of frequency components with zero amplitude include a case where the tonality of the stereo signal is high. For example, in a case where the stereo signal includes many frequency components with zero amplitude, the weighting by the reciprocal of the amplitude component (for example, whitening) with respect to the frequency components with zero amplitude may not be appropriate in the ITD estimation by the GCC-PHAT method. In this case, the estimation performance of the ITD may deteriorate (for example, the ITD may become zero).

In a non-limiting embodiment of the present disclosure, a method for improving the estimation performance of ITD and the encoding performance even in a case where a stereo signal includes a large number of frequency components with zero amplitude will be described.

In a non-limiting embodiment of the present disclosure, a robust ITD estimation method is described for cases where an input signal (for example, a stereo signal) contains a large number of frequency components with zero amplitude (for example, when the signal has a high tonality). For example, when performing ITD estimation, the weighting based on the cross spectrum amplitude is adaptively changed (or altered) according to a parameter related to the stereo signal (for example, the maximum amplitude of the cross spectrum, spectral flatness measurement (SFM), and the like). Thus, it is possible to improve the estimation performance of ITD even in a case where the stereo signal includes a large number of frequency components with zero amplitude (for example, in a case where the tonality is high).

### Embodiment 1

### Exemplary Configuration of Transmission System for Speech/Acoustic Signal

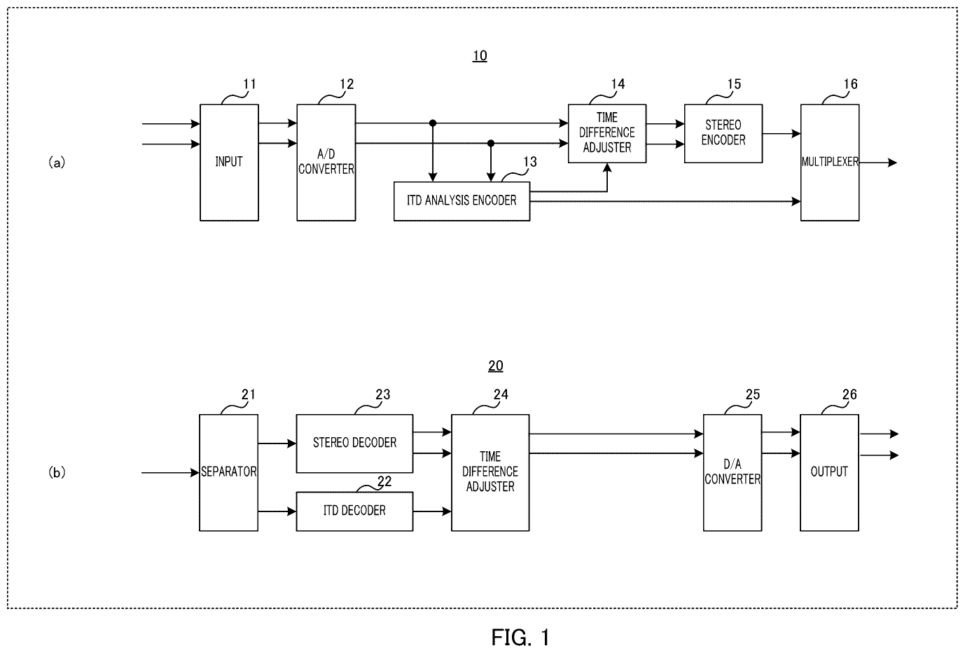

FIG. 1 illustrates an exemplary configuration of a transmission system for a speech signal or an acoustic signal (for example, referred to as a speech audio signal). Part (a) in FIG. 1 illustrates an exemplary configuration of a speech audio signal encoding apparatus (hereinafter referred to as “encoding apparatus”), and part (b) in FIG. 1 illustrates an exemplary configuration of a speech audio signal decoding apparatus (hereinafter referred to as “decoding apparatus”).

### Exemplary Configuration of Encoding Apparatus

Encoding apparatus 10 illustrated in part (a) in FIG. 1 may include, for example, input 11, A/D converter 12, ITD analysis encoder 13, time difference adjuster 14, stereo encoder 15, and multiplexer 16.

Input 11 converts, for example, an inputted speech audio signal (for example, air vibration) into an electrical signal (for example, an analog signal) and outputs the analog signal to A/D converter 12.

A/D converter 12 converts, for example, the analog signal inputted from input 11 into a digital signal, and outputs the digital signal to ITD analysis encoder 13 and time difference adjuster 14.

Note that, encoding apparatus 10 may include a plurality of (for example, two) inputs 11 and/or A/D converters 12 (at least one of them) in order to handle a stereo signal.

ITD analysis encoder 13 estimates and encodes the inter-channel time difference (ITD) of the stereo signal inputted from, for example, A/D converter 12. ITD analysis encoder 13 outputs the estimated ITD (for example, the ITD obtained by decoding the encoding result) to time difference adjuster 14, and outputs the encoding result of the ITD to multiplexer 16. For example, ITD analysis encoder 13 may perform processing of identifying a time lag with respect to a peak position of an inter-channel cross correlation in the time domain obtained by IFFT of a cross spectrum calculated from FFT spectra of a pair of channel signals of the stereo signal. Further, ITD analysis encoder 13 may perform weighting based on the reciprocal of the amplitude of the cross spectrum, for example, during ITD estimation. An example of the processing in ITD analysis encoder 13 will be described later.

Time difference adjuster 14 performs a process of adjusting the time difference between the L channel and the R channel of the stereo signal inputted from A/D converter 12 using the ITD inputted from ITD analysis encoder 13 (for example, a process of eliminating a temporal shift and aligning the channels), and outputs the adjusted stereo signal to stereo encoder 15.

Stereo encoder 15 encodes the time-adjusted stereo signal inputted from time difference adjuster 14 and outputs the encoding result to multiplexer 16.

Hereinafter, an exemplary configuration inside stereo encoder 15 will be described.

Stereo encoder 15 may include, for example, a converter (for example, an FFT section) that converts a signal from the time domain to a signal in the frequency domain, a stereo information extractor, a downmixer, and an encoder (not illustrated).

The converter converts, for example, a stereo signal (for example, an L-channel signal and an R-channel signal) input to stereo encoder 15 into data in the frequency domain (for example, an FFT spectrum) for each channel from the time domain, and outputs the data to the stereo information extractor and the downmixer.

The stereo information extractor may, for example, extract stereo information, based on the FFT spectrum of each channel. For example, the stereo information extractor may parameterize the stereo signal with binaural cues such as inter-channel level difference (ILD), ICC, and inter-channel phase difference (IPD), and output the parameterized stereo signal to the downmixer and the encoder.

The downmixer may, for example, modify (or adjust) at least one FFT spectrum of the L channel and the R channel based on the FFT spectrum of each channel output from the converter and the parameters of the binaural cues output from the stereo information extractor, perform downmixing processing, and generate a Mid signal (for example, also referred to as an M signal) and a Side signal (for example, also referred to as an S signal). For example, the downmixer may perform a downmix such that M=(L′+R′)/2 and S=(L′−R′)/2, and may output the M signal and the S signal to the encoder. Here, M represents the Mid signal, S represents the Side signal, L′ represents the modified FFT spectrum of the L channel, and R′ represents the modified FFT spectrum of the R channel.

The encoder respectively encodes, for example, the M signal and the S signal output from the downmixer, and the parameters of the binaural cues output from the stereo information extractor, and outputs the encoded data as the output signal of stereo encoder 15.

The above is a description of an exemplary configuration inside stereo encoder 15.

Note that stereo encoder 15 is not limited to the encoding method described above, and may include, for example, various standardized speech audio codecs such as those from the Moving Picture Experts Group (MPEG), the 3rd Generation Partnership Project (3GPP), or the International Telecommunication Union Telecommunication Standardization Sector (ITU-T).

Multiplexer 16 multiplexes the encoded data (for example, referred to as stereo encoding information) inputted from stereo encoder 15 and the encoded data (for example, referred to as ITD encoding information) inputted from ITD analysis encoder 13, and transmits the multiplexed encoding information to decoding apparatus 20 via a communication network or a storage medium (not illustrated).

### Exemplary Configuration of Decoding Apparatus

Decoding apparatus 20 illustrated in part (b) in FIG. 1 may include, for example, separator 21, ITD decoder 22, stereo decoder 23, time difference adjuster 24, D/A converter 25, and output 26.

Separator 21 receives the encoding information via, for example, the communication network or the storage medium (not illustrated), separates the multiplexed encoding information, outputs the ITD encoding information to ITD decoder 22, and outputs the stereo encoding information to stereo decoder 23.

ITD decoder 22 decodes ITD from the ITD encoding information inputted from separator 21, and outputs the decoded ITD (hereinafter, referred to as decoded ITD) to time difference adjuster 24.

Stereo decoder 23 decodes a stereo signal from the stereo encoding information inputted from separator 21, and outputs the decoded stereo signal (hereinafter, referred to as a decoded stereo signal) to time difference adjuster 24.

Hereinafter, an exemplary configuration inside stereo decoder 23 will be described.

Stereo decoder 23 may include, for example, a decoder, an upmixer, a stereo information synthesizer, and a converter (for example, an IFFT section) that converts a signal from the frequency domain to a time domain signal (not illustrated).

The decoder decodes the input stereo encoding information using a decoding method corresponding to the encoding method used on encoding apparatus 10 side, and outputs, for example, the M signal and the S signal, and the parameters of the binaural cues to the upmixer and the stereo information synthesizer. The decoder may be provided with, for example, a variety of standardized speech audio codecs, such as MPEG, 3GPP, or ITU-T.

The upmixer may perform upmixing processing based on, for example, the M signal and the S signal inputted from the decoder. For example, the upmixer performs upmixing processing such that L′=M+S and R′=M−S, and outputs the L′ signal and the R′ signal of the FFT spectrum to the stereo information synthesizer.

The stereo information synthesizer may, for example, perform a reverse operation to the operation of encoding apparatus 10 (for example, the stereo information extractor) using the parameters of the binaural cues inputted from the decoder and the L′ signal and R′ signal of the FFT spectrum inputted from the upmixer, and may output the L signal and R signal of the FFT spectrum to the converter.

The converter converts, for example, the L signal and the R signal of the FFT spectrum into digital signals of the L channel and the R channel in the time domain on a channel-by-channel basis, and outputs the digital signals as output signals (for example, decoded stereo signals) from stereo decoder 23.

The configuration example of stereo decoder 23 has been described above.

Time difference adjuster 24 performs adjustment of the inter-channel time difference (for example, a process of returning the signal subjected to time alignment to a signal having the original time difference) on the decoded stereo signal inputted from stereo decoder 23 using the decoded ITD inputted from ITD decoder 22, and outputs the decoded stereo signal after the time adjustment to D/A converter 25.

D/A converter 25 converts the digital signal inputted from, for example, time difference adjuster 24 into a speech audio signal (analog signal) and outputs the speech audio signal to output 26.

Output 26 converts the analog signal inputted from D/A converter 25 into, for example, air vibrations via a speaker and outputs the air vibrations.

Note that, decoding apparatus 20 may include a plurality (for example, two) of at least one of D/A converters 25 and outputs 26 in order to handle a stereo signal.

### Configuration Example of ITD Analysis Encoder

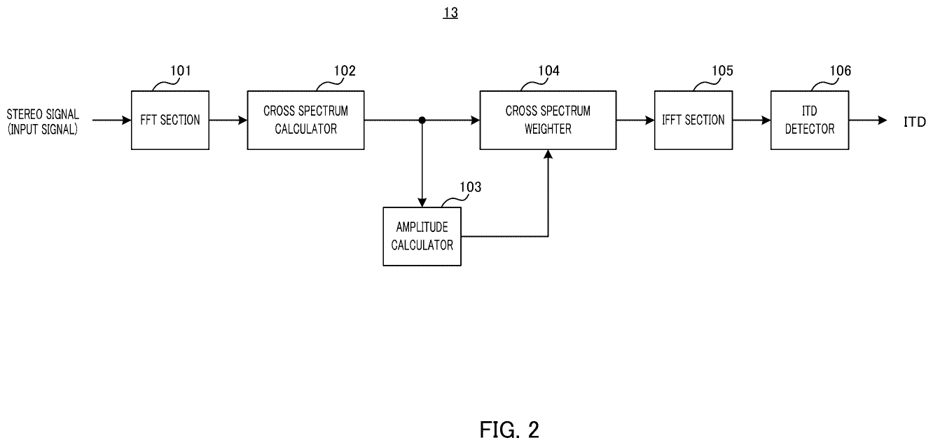

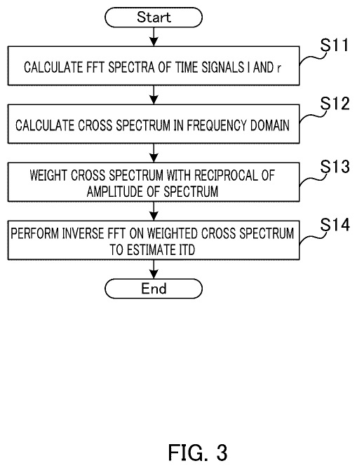

Next, an exemplary configuration of ITD analysis encoder 13 will be described. FIG. 2 is a block diagram illustrating an exemplary configuration of ITD analysis encoder 13. FIG. 3 is a flowchart illustrating an exemplary operation of ITD analysis encoder 13 illustrated in FIG. 2.

ITD analysis encoder 13 performs weighting on the cross spectrum using, for example, the reciprocal of the amplitude of the cross spectrum.

ITD analysis encoder 13 illustrated in FIG. 2 (corresponding to, for example, a signal processing apparatus) may include, for example, FFT section 101, cross spectrum calculator 102, amplitude calculator 103, cross spectrum weighter 104 (corresponding to, for example, control circuitry), IFFT section 105, and ITD detector 106 (corresponding to, for example, detection circuitry).

For example, a stereo signal in the time domain (for example, L channel (for example, represented by “l”) and R channel (for example, represented by “r”)) may be input into FFT section 101 independently on a channel-by-channel basis. FFT section 101 converts, for example, a channel signal in the time domain into a frequency domain signal (hereinafter, referred to as an “FFT spectrum”) (for example, S11 in FIG. 3). FFT section 101 outputs information on the FFT spectrum to cross spectrum calculator 102. A method of converting from the time-domain signal to the frequency-domain signal is not limited to FFT and may be other methods.

Cross spectrum calculator 102 calculates the cross spectrum based on the FFT spectrum of each channel inputted from FFT section 101 (for example, S12 in FIG. 3). Cross spectrum calculator 102 outputs information on the obtained cross spectrum to amplitude calculator 103 and cross spectrum weighter 104.

Amplitude calculator 103 calculates the amplitude (or referred to as an amplitude spectrum) of the cross spectrum based on information on the cross spectrum inputted from cross spectrum calculator 102, for example, and outputs information on the amplitude spectrum of the cross spectrum to cross spectrum weighter 104.

Cross spectrum weighter 104 calculates, for example, the reciprocal of the amplitude spectrum of the cross spectrum inputted from amplitude calculator 103, and sets the reciprocal of the amplitude spectrum as the weighting coefficient. Then, cross spectrum weighter 104 performs weighting on the cross spectrum inputted from cross spectrum calculator 102 with the weighting coefficient (for example, the reciprocal of the cross spectrum amplitude) (for example, S13 in FIG. 3). Cross spectrum weighter 104 outputs the weighted cross spectrum to IFFT section 105.

IFFT section 105 converts the cross spectrum weighted in cross spectrum weighter 104, for example, into a signal in the time domain from the frequency domain (for example,

S14 in FIG. 3). IFFT section 105 outputs the weighted cross-correlation function (for example, the whitened cross-correlation function) to ITD detector 106. A method of converting from the frequency-domain signal to the time-domain signal is not limited to IFFT and may be other methods.

ITD detector 106 detects (or estimates) ITD based on, for example, the cross-correlation function (also referred to as, for example, a whitening cross-correlation function) output from IFFT section 105 (for example, S14 in FIG. 3).

For example, cross-correlation function CSP_{1,2}(τ) obtained in IFFT section 105 is represented as follows in Equation 1-1.

$${CSP}_{1 , 2} ( τ ) = {\int }_{- ∞}^{∞} {Φ}_{1 , 2} ( ω ) \cdot Wg \cdot exp ( - j ωτ ) dw \qquad ( Equation 1 - 1 )$$

In Equation 1-1, Φ_{1,2}(ω) represents a cross spectrum. Further, Wg represents a weighting coefficient and is represented as in following Equation 1-2.

$$Wg = \frac{1}{\vert {Φ}_{1 , 2} ( ω ) \vert} \qquad ( Equation 1 - 2 )$$

In Equation 1-2, |Φ_{1,2}(ω)| represents the amplitude (amplitude spectrum) of the cross spectrum.

As described above, ITD analysis encoder 13 illustrated in FIG. 2 detects ITD based on the cross spectrum weighted with weighting coefficient Wg based on cross spectrum amplitude |Φ_{1,2}(ω)| of the stereo signal.

As described above, in ITD analysis encoder 13, for example, when a stereo signal includes a large number of frequency components (for example, FFT spectrum components) with zero amplitude, the weighting in the whitening of the cross spectrum with weighting coefficient Wg based on the reciprocal of the cross spectrum amplitude may become inappropriate, and the estimation performance of ITD may decrease. Hereinafter, a method for improving the estimation accuracy of ITD will be described as an example, even in a case where a stereo signal includes a large number of frequency components (for example, FFT spectrum components) with zero amplitude.

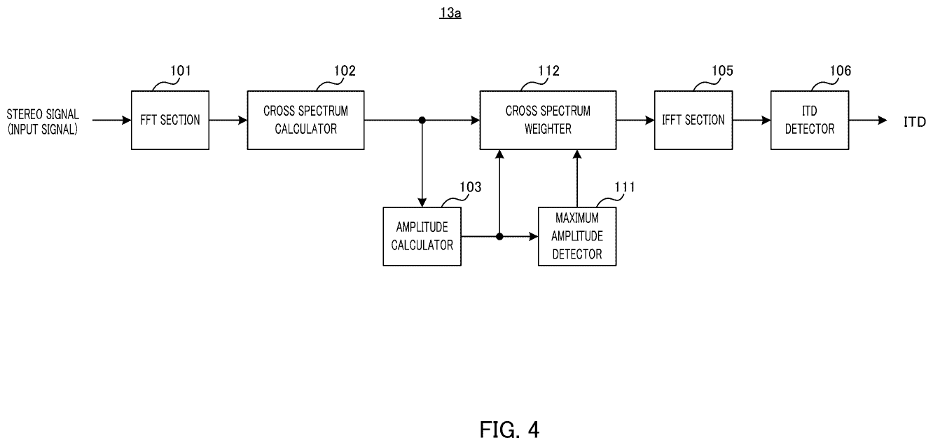

FIG. 4 is a block diagram illustrating an exemplary configuration of ITD analysis encoder 13a according to the present embodiment.

As compared, for example, to the configuration of ITD analysis encoder 13 illustrated in FIG. 2, ITD analysis encoder 13a (corresponding to, for example, a signal processing apparatus) illustrated in FIG. 4 additionally includes maximum amplitude detector 111, and cross spectrum weighter 104 is replaced with cross spectrum weighter 112 (corresponding to, for example, control circuitry). In ITD analysis encoder 13a illustrated in FIG. 4, components other than maximum amplitude detector 111 and cross spectrum weighter 112 may be the same as those in FIG. 2, for example.

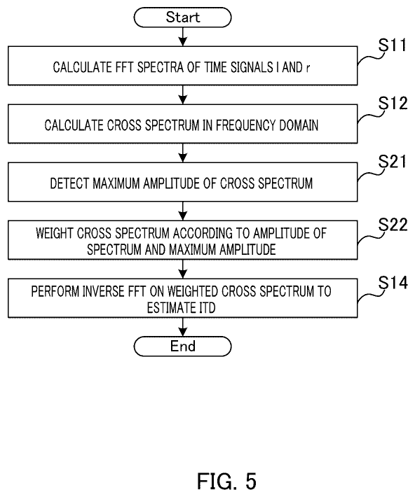

FIG. 5 is a flowchart illustrating an exemplary operation of ITD analysis encoder 13a illustrated in FIG. 4. In FIG. 5, the same processing as in FIG. 3 is denoted by the same reference numerals, and the description thereof will be omitted.

In FIG. 4, maximum amplitude detector 111 detects the maximum value of the amplitude of the cross spectrum (for example, referred to as the maximum amplitude) based on the amplitude spectrum of the cross spectrum of the current frame inputted from amplitude calculator 103 (S21 illustrated in FIG. 5). Maximum amplitude detector 111 outputs information on the maximum amplitude of the detected cross spectrum to cross spectrum weighter 112.

Cross spectrum weighter 112 sets (or calculates) a weighting coefficient based on, for example, the amplitude spectrum of the cross spectrum inputted from amplitude calculator 103 and the maximum amplitude of the cross spectrum inputted from maximum amplitude detector 111. Then, cross spectrum weighter 112 performs weighting on the cross spectrum inputted from cross spectrum calculator 102 with the weighting coefficient (for example, S22 in FIG. 5). Cross spectrum weighter 112 outputs the weighted cross spectrum to IFFT section 105.

Note that, maximum amplitude detector 111 may output information on the position of the maximum amplitude of the cross spectrum (for example, information indicating which spectrum component has the maximum amplitude) to cross spectrum weighter 112 instead of the information regarding the maximum amplitude of the cross spectrum. In this case, cross spectrum weighter 112 may determine the amplitude spectrum corresponding to the position of the maximum amplitude inputted from maximum amplitude detector 111 as the maximum amplitude of the cross spectrum among the amplitude spectra of the cross spectra inputted from amplitude calculator 103.

For example, cross-correlation function AdpCSP_{1,2}(τ) obtained in IFFT section 105 is represented as follows in Equation 2-1:

$${AdpCSP}_{1 , 2} ( τ ) = {\int }_{- ∞}^{∞} {Φ}_{1 , 2} ( ω ) \cdot AdpWg \cdot exp ( - j ωτ ) d ω . \qquad ( Equation 2 - 1 )$$

In Equation 2-1, Φ_{1,2}(ω) represents the cross spectrum. Further, AdpWg indicates a weighting coefficient and is represented as in the following Equation 2-2:

$$AdpWg = \frac{1}{\vert {Φ}_{1 , 2} ( ω ) \vert + C} . \qquad ( Equation 2 - 2 )$$

In Equation 2-2, |Φ_{1,2}(ω)| represents the amplitude (amplitude spectrum) of the cross spectrum, and C represents a weight control coefficient for altering weighting coefficient AdpWg according to the maximum amplitude of the cross spectrum. As described above, ITD analysis encoder 13a alters weighting coefficient AdpWg based on amplitude |Φ_{1,2}(ω)| of the cross spectrum according to the maximum amplitude of the cross spectrum.

For example, the value of C in Equation 2-2 may be set to a constant of approximately 1/10,000 to 1/100,000 of the maximum amplitude of the cross spectrum. In this case, weight control coefficient C shown in Equation 2-2 is sufficiently small for a component (for example, a peak component) with a large amplitude |Φ_{1,2}(ω)|, and is unlikely to affect the setting of weighting coefficient AdpWg (for example, the value is as small as an error). On the other hand, weight control coefficient C shown in Equation 2-2 is large for a component with a small amplitude |Φ_{1,2}(ω)| (for example, a zero amplitude component), and is likely to affect the setting of weighting coefficient AdpWg. For this reason, for example, weighting coefficient AdpWg shown in Equation 2-2 may have a value that is substantially the reciprocal of the amplitude for a component (for example, a peak component) with a large amplitude |Φ_{1,2}(ω)|, and may have a value that is substantially zero for a component (for example, a zero amplitude component) with an amplitude close to zero.

Thus, for example, the calculation formula of weighting coefficient AdpWg (for example, Equation 2-2) is kept with a small change from Equation 1-2 (for example, only the addition of weight control coefficient C), and cross spectrum weighter 112 can perform weighting on the cross spectrum according to the maximum amplitude of the cross spectrum.

As described above, in the present embodiment, ITD analysis encoder 13a alters the weighting coefficient for the cross spectrum according to the maximum amplitude of the cross spectrum.

For example, ITD analysis encoder 13a can weight a component with a large amplitude with a value approximately equal to the reciprocal of the cross spectrum amplitude, thereby whitening the cross spectrum. Further, for example, ITD analysis encoder 13a can perform weighting on a component with a small amplitude with a value smaller than the reciprocal of the cross spectrum amplitude, and can further reduce the amplitude component (for example, can suppress or weaken the amplitude component). Thus, even in a case where the stereo signal includes a large number of frequency components with zero amplitude (for example, in a case where the tonality is high), ITD analysis encoder 13a can appropriately perform the weighting on the cross spectrum, and can improve the estimation accuracy of ITD.

Thus, according to the present embodiment, it is possible to improve the estimation accuracy of ITD and to improve the encoding performance even in a case where a stereo signal includes a large number of frequency components with zero amplitude.

Note that, weight control coefficient C may be represented by, for example, C=|CrSpMax|·D. Here, CrSpMax indicates the maximum amplitude of the cross spectrum detected in maximum amplitude detector 111. Further, D is a coefficient for adjusting C, and may take a value such as D=10^{-α} or D=2^{-β}, for example. For example, α and β are coefficients for adjusting the influence (for example, the degree) of the strength of the weighting.

For example, coefficient α can take a positive value. The smaller the value of coefficient α, the smaller weighting coefficient AdpWg becomes, and the more easily the zero-amplitude frequency component is weakened. On the other hand, the larger the value of coefficient α, the larger weighting coefficient AdpWg becomes. For example, when α>10, the weighting is equivalent to the weighting without using weight control coefficient C (for example, Equation 1-2). Further, for example, it has been experimentally found that a value in the range of 3≤α≤6 is desirable.

Further, for example, coefficient β can take a positive value. The smaller the value of coefficient β, the smaller weighting coefficient AdpWg becomes, and the frequency component with zero amplitude is more likely to be weakened. On the other hand, the larger the value of coefficient β, the larger weighting coefficient AdpWg becomes. For example, it has been experimentally found that a value in the range of 10≤β≤20 is desirable.

Note that the calculation method of C and the calculation method of D (for example, the set values of α and β) are not limited to the examples described above.

### Embodiment 2

In the present embodiment, a case where ITD estimation is performed using the spectral flatness measurement (SFM) will be described.

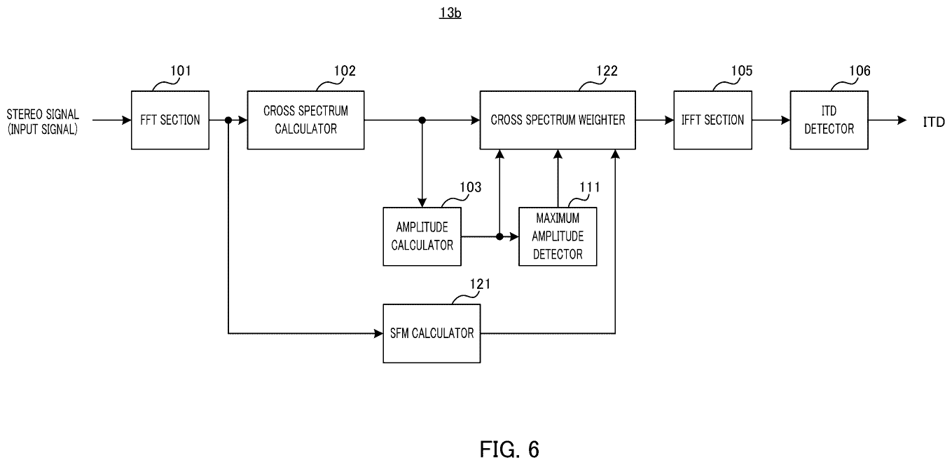

FIG. 6 is a block diagram illustrating an exemplary configuration of ITD analysis encoder 13b according to the present embodiment.

As compared, for example, to the configuration of ITD analysis encoder 13a illustrated in FIG. 4, ITD analysis encoder 13b (corresponding to, for example, a signal processing apparatus) illustrated in FIG. 6 additionally includes SFM calculator 121, and cross spectrum weighter 112 is replaced with cross spectrum weighter 122 (corresponding to, for example, control circuitry). In ITD analysis encoder 13b illustrated in FIG. 6, components other than SFM calculator 121 and cross spectrum weighter 122 may be the same as those in FIG. 2 or FIG. 4, for example.

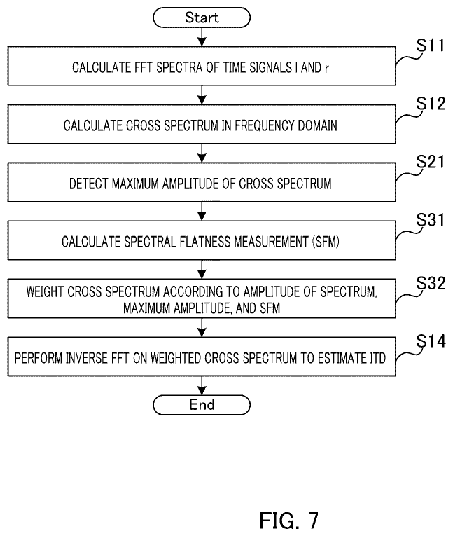

FIG. 7 is a flowchart illustrating an exemplary operation of ITD analysis encoder 13b illustrated in FIG. 6. In FIG. 7, the same reference numerals are given to the same processes as those in FIG. 5, and the description thereof will be omitted.

In FIG. 6, SFM calculator 121 calculates the spectral flatness measurement (SFM) based on the FFT spectrum of each channel inputted from, for example, FFT section 101 (for example, S31 in FIG. 7). For example, the stronger the tonality or periodicity of the input signal, the lower the SFM becomes (see, for example, PTL 1 for SFM). SFM calculator 121 outputs information on the calculated SFM to cross spectrum weighter 122.

Cross spectrum weighter 122 sets (or calculates) the weighting coefficient based on, for example, the amplitude spectrum of the cross spectrum inputted from amplitude calculator 103, the maximum amplitude of the cross spectrum inputted from maximum amplitude detector 111, and the SFM inputted from SFM calculator 121. Then, cross spectrum weighter 122 performs weighting on the cross spectrum inputted from cross spectrum calculator 102 with the weighting coefficient (for example, S32 in FIG. 7). Cross spectrum weighter 122 outputs the weighted cross spectrum to IFFT section 105.

For example, cross-correlation function AdpCSP_{1,2}(τ) obtained in IFFT section 105 is represented as follows in Equation 3-1:

$${AdpCSP}_{1 , 2} ( τ ) = {\int }_{- ∞}^{∞} {Φ}_{1 , 2} ( ω ) \cdot AdpWg \cdot exp ( - j ωτ ) d ω . \qquad ( Equation 3 - 1 )$$

In Equation 3-1, Φ_{1,2}(ω) represents the cross spectrum. Further, AdpWg indicates a weighting coefficient and is represented as in the following Equation 3-2:

$$AdpWg = \frac{1}{\vert {Φ}_{1 , 2} ( ω ) \vert + C \times ( 1 - sfm )} . \qquad ( Equation 3 - 2 )$$

In Equation 3-2, |Φ_{1,2}(ω)| represents the amplitude (amplitude spectrum) of the cross spectrum, C represents a weight control coefficient for altering weighting coefficient AdpWg according to the maximum amplitude of the cross spectrum, and sfm is a parameter indicating the spectral flatness measurement.

For example, the flatter the FFT spectrum of the stereo signal is (or the lower the tonality), the closer the value of sfm is to 1.0. Conversely, the less flat the FFT spectrum of the stereo signal is (or the higher the tonality), the closer the value of sfm is to 0. Thus, for example, in Equation 3-2, the flatter the FFT spectrum of the stereo signal is (or the lower the tonality), the closer the value of (1−sfm) is to 0, and the less flat the FFT spectrum of the stereo signal is (or the higher the tonality), the closer the value of (1−sfm) is to 1.0.

Further, in Equation 3-2, coefficient C may be the same weight control coefficient as in Embodiment 1.

In Equation 3-2, weight control coefficient C is multiplied by (1−sfm). Thus, weighting coefficient AdpWg is set smaller as spectral flatness measurement sfm is lower (for example, as the tonality is higher).

For example, in Equation 3-2, the lower the tonality (the larger the sfm), the smaller the influence of weight control coefficient C on the setting of weighting coefficient AdpWg, and weighting coefficient AdpWg is controlled to approach the value of Wg shown in Equation 1-2. Thus, the lower the tonality, the larger weighting coefficient Adpwg for a component with a small amplitude becomes, and the cross spectrum is more likely to be whitened.

On the other hand, for example, in Equation 3-2, the higher the tonality (the smaller the sfm), the greater the influence of weight control coefficient C on the setting of weighting coefficient AdpWg, and weighting coefficient AdpWg is controlled to approach the value of

AdpWg shown in Equation 2-2. Thus, the higher the tonality, the smaller weighting coefficient AdpWg for a component with a small amplitude (for example, a zero amplitude component), and such a component of the cross spectrum is reduced (for example, weakened).

Thus, for example, the calculation formula of weighting coefficient AdpWg (for

example, Equation 3-2) is kept with a small change from Equation 1-2 (for example, only the addition of weight control coefficient C and spectral flatness measurement sfm), and cross spectrum weighter 122 can perform weighting on the cross spectrum according to the maximum amplitude of the cross spectrum and the flatness (or tonality) of the spectrum.

As described above, in the present embodiment, ITD analysis encoder 13b alters the weighting coefficient for the cross spectrum according to the maximum amplitude of the cross spectrum and the spectral flatness measurement of the stereo signal.

For example, ITD analysis encoder 13b can weight the cross spectrum with a value approximately equal to the reciprocal of the cross spectrum amplitude for a stereo signal with low tonality, thereby whitening the cross spectrum. Further, for example, ITD analysis encoder 13b performs weighting according to the magnitude of the amplitude (for example, the maximum amplitude of the cross spectrum) for a stereo signal with a high tonality, and can further reduce (for example, suppress or weaken) a component with a small amplitude of the cross spectrum.

Thus, even in a case where the stereo signal includes a large number of frequency components with zero amplitude (for example, in a case where the tonality is high), ITD analysis encoder 13b can appropriately perform the weighting on the cross spectrum and can improve the estimation accuracy of ITD. Further, ITD analysis encoder 13b can stably perform ITD estimation according to the tonality based on the spectral flatness measurement (SFM), and can improve the estimation accuracy of ITD.

Thus, according to the present embodiment, it is possible to improve the estimation accuracy of ITD and to improve the encoding performance even in a case where a stereo signal includes a large number of frequency components with zero amplitude.

### Variation 1 of Embodiment 2

For example, cross spectrum weighter 122 may compare spectral flatness measurement sfm with threshold Th and alter the weighting coefficient for each frame processing.

For example, cross spectrum weighter 122 may set a first weighting coefficient in a case where spectral flatness measurement sfm is equal to or larger than threshold Th, and may set a second weighting coefficient smaller than the first weighting coefficient in a case where spectral flatness measurement sfm is smaller than threshold Th. Thus, for example, in a case where spectral flatness measurement sfm is less than threshold Th (for example, in a case where the tonality is high), the component with a small amplitude can be reduced by weighting.

Hereinafter, an example of setting the weighting coefficient will be described. Note that the meanings of the following weighting coefficients are as described in Embodiment 1 and Embodiment 2 above.

### Example 1

For example, cross spectrum weighter 122 may set the following weighting coefficient in a case where sfm≥Th:

$$Weighting coefficient = \frac{1}{\vert {Φ}_{1 , 2} ( ω ) \vert} . \qquad ( Equation 4 )$$

Further, for example, cross spectrum weighter 122 may set the following weighting coefficient in a case where sfm<Th:

$$Weighting coefficient = \frac{1}{\vert {Φ}_{1 , 2} ( ω ) \vert + C} . \qquad ( Equation 5 )$$

### Example 2

For example, cross spectrum weighter 122 may set the following weighting coefficient in a case where sfm≥Th:

$$Weighting coefficient = \frac{1}{\vert {Φ}_{1 , 2} ( ω ) \vert} . \qquad ( Equation 6 )$$

Further, for example, cross spectrum weighter 122 may set the following weighting coefficient in a case where sfm<Th:

$$Weighting coefficient = \frac{1}{\vert {Φ}_{1 , 2} ( ω ) \vert + C \times ( 1 - sfm )} . \qquad ( Equation 7 )$$

### Example 3

For example, cross spectrum weighter 122 may set the following weighting coefficient in a case where sfm≥Th1:

$$Weighting coefficient = \frac{1}{\vert {Φ}_{1 , 2} ( ω ) \vert} . \qquad ( Equation 8 )$$

Further, for example, cross spectrum weighter 122 may set the following weighting coefficient in a case of Th2≤sfm<Th1:

$$Weighting coefficient = \frac{1}{\vert {Φ}_{1 , 2} ( ω ) \vert + C \times ( 1 - sfm )} . \qquad ( Equation 9 )$$

Further, for example, cross spectrum weighter 122 may set the following weighting coefficient in a case where sfm<Th2:

$$Weighting coefficient = \frac{1}{\vert {Φ}_{1 , 2} ( ω ) \vert + C} . \qquad ( Equation 10 )$$

### Variation 2 of Embodiment 2

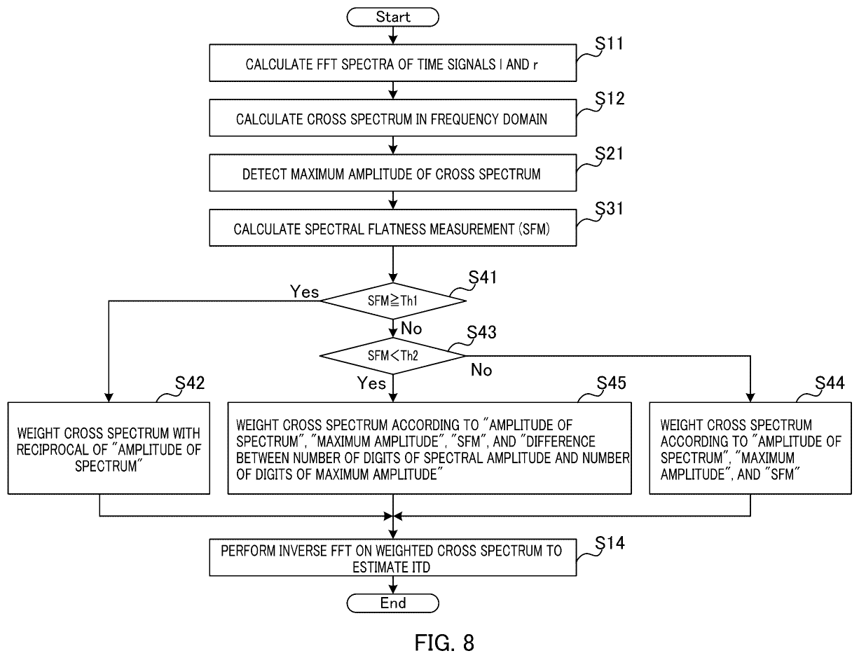

FIG. 8 is a flowchart illustrating an exemplary operation of ITD analysis encoder 13b according to Variation 2. In FIG. 8, the same reference numerals are given to the same processes as those in FIGS. 3, 5, and 7, and the description thereof will be omitted.

In a case where sfm>Th1 (S41: Yes), cross spectrum weighter 122 performs weighting on the cross spectrum with a weighting coefficient based on the reciprocal of the cross spectrum amplitude, for example, as in Equation 1-2 (S42).

Further, in a case where Th2≤sfm<Th1 (S41: No and S43: No), cross spectrum weighter 122 performs weighting on the cross spectrum with a weighting coefficient based on the cross spectrum amplitude, the maximum amplitude of the cross spectrum, and SFM, for example, as in Equation 3-2 (S44). Note that the weighting in the processing of S44 is not limited to this, and may be, for example, weighting based on the amplitude of the cross spectrum and a weighting coefficient based on the maximum amplitude of the cross spectrum as in Equation 2-2.

Further, in a case where sfm<Th2 (S43: Yes), cross spectrum weighter 122 performs weighting on the cross spectrum with a weighting coefficient based on, for example, the cross spectrum amplitude, the maximum amplitude of the cross spectrum, SFM, and a difference between the number of digits of the cross spectrum amplitude and the number of digits of the maximum amplitude of the cross spectrum (hereinafter, also referred to as “difference in number of digits of amplitude) (S45).

Further, for example, in the processing of S42 and S44, cross spectrum weighter 122 applies uniform weighting to all cross spectra within each frame. In the processing of S45, cross spectrum weighter 122 may apply weighting individually to each spectral component (for example, spectrum bin) in each frame, for example.

For example, cross spectrum weighter 122 may alter the value of α, which is a parameter of weight control coefficient C (=|CrSpMax|·D, where D=10^{-α}) corresponding to the maximum amplitude of the cross spectrum, according to the difference in number of digits of amplitude (for example, the number of digits of the cross spectrum maximum amplitude−the number of digits of the cross spectrum amplitude). Cross spectrum weighter 122 may, for example, set a smaller value of α (for example, set larger weight control coefficient C) to set a smaller weighting coefficient as the difference in number of digits of amplitude is larger.

For example, a case where the default value for the value of α in weight control coefficient C is set to α=5 and threshold Th2 of sfm illustrated in FIG. 8 is set to Th2=0.2 will be described. Note that the value of Th2 is not limited to 0.2 and may be another value.

For example, in a case where sfm<Th2 (for example, sfm<0.2), cross spectrum weighter 122 may set a weighting coefficient for each spectrum bin (ω) and perform weighting on the cross spectrum based on the set weighting coefficient.

For example, in a case where the difference in number of digits of amplitude is 3 or less at ω=ω₁ (for example, the number of digits of the cross spectrum maximum amplitude−the number of digits of the cross spectrum amplitude≤3), cross spectrum weighter 122 may set the value of α to 5. For example, weight control coefficient C is set to |CrSpMax|·10⁻⁵.

Further, for example, in a case where the difference in number of digits of amplitude is larger than 3 and is 5 or less at ω=ω₂ (for example, 3<(number of digits of the cross spectrum maximum amplitude-number of digits of the cross spectrum amplitude)≤5), cross spectrum weighter 122 may set (or replace) the value of α to 4. For example, weight control coefficient C is set to |CrSpMax|·10⁻⁴. Thus, the weighting coefficient is set to be smaller compared to the default value (α=5), and the amplitude of the cross spectrum is likely to be reduced.

Further, for example, in a case where the number of digits of the amplitude is larger than 5 at ω=ω₃ (for example, the number of digits of the cross spectrum maximum amplitude−the number of digits of the cross spectrum amplitude>5), cross spectrum weighter 122 may set (or replace) the value of α to 3. For example, weight control coefficient C is set to |CrSpMax|·10⁻³. Thus, the weighting coefficient is set to be further smaller compared to the case of the default value (α=5) and the case of α=4, and the amplitude of the cross spectrum is more likely to be reduced.

As described above, the larger the difference in number of digits of amplitude of the cross spectrum, the smaller the weighting coefficient is set, and thus, the component with an amplitude smaller than the peak (maximum amplitude) (for example, a frequency component with zero amplitude) can be weakened by weighting in each component of the cross spectrum, thereby improving the estimation performance of ITD.

Note that, in FIG. 8, the case where weighting is performed using the cross spectrum amplitude, the maximum amplitude of the cross spectrum, the SFM, and the number of digits difference of the amplitude in the processing of S45 has been described, but the present disclosure is not limited thereto. For example, cross spectrum weighter 122 may perform weighting using the cross spectrum amplitude, the maximum amplitude of the cross spectrum, and the number of digits difference of the amplitude (for example, without using SFM).

Alternatively, for example, cross spectrum weighter 122 may perform weighting using the cross spectrum amplitude and the number of digits difference of the amplitude (for example, without using the maximum amplitude of the cross spectrum and SFM). In this case, for example, C=10^{α} may be applied as weight control coefficient C in the weighting coefficient, and weight control coefficient C (value of α) may be set according to the difference in number of digits of amplitude.

Further, FIG. 8 has described a case where two thresholds Th1 and Th2 are used, but the present disclosure is also applicable to a case where one threshold is used or a case where three or more thresholds are used.

Further, the value of α is not limited to the range of 3 to 5, and may be another value.

Further, in Variation 2, the example in which the weighting coefficient is set according to the difference in number of digits of amplitude of the cross spectrum has been described, but the present invention is not limited thereto. For example, the weighting coefficient may be set according to a value representing the difference (or ratio) between the amplitude of each spectrum bin of the cross spectrum and the maximum amplitude of the cross spectrum.

Further, in Variation 2, the setting of the weighting coefficient for each spectrum bin has been described as an example, but the unit for setting the weighting coefficient is not limited to the unit of the spectrum bin, and may be, for example, a unit of a group including at least one spectrum bin.

### Variation 3 of Embodiment 2

In Variation 3, cross spectrum weighter 122 adaptively controls the weighting coefficient for the spectrum bin with respect to, for example, the maximum or minimum of the spectrum (hereinafter, referred to as “peak of the spectrum”).

For example, the peak position of the spectrum may be detected based on a position at which a difference spectrum is inverted between positive and negative values. Note that the method for detecting the peak position of the spectrum is not limited to a method based on the position of positive-negative inversion of the difference spectrum, and may be another method.

Further, the peak position of the spectrum may be limited to a peak larger than a certain threshold based on the maximum amplitude of the spectrum. For example, cross spectrum weighter 122 may not use a peak with an amplitude equal to or less than the threshold as the peak position of the spectrum.

Cross spectrum weighter 122 may set (or change, switch) the weighting coefficient for each frame processing as follows, for example, using sfm and threshold Th for sfm. Note that the meaning of the weighting coefficient is as described in Embodiment 1, Embodiment 2, and the modifications described above.

For example, cross spectrum weighter 122 may set the following weighting coefficient in a case where sfm≥Th:

$$Weighting coefficient = \frac{1}{\vert {Φ}_{1 , 2} ( ω ) \vert} . \qquad ( Equation 11 )$$

Further, for example, cross spectrum weighter 122 may set the following weighting coefficient in a case where sfm<Th. For example, cross spectrum weighter 122 may set a first weighting coefficient for the detected peak position, and may set a second weighting coefficient smaller than the first weighting coefficient for a position different from the peak position.

$$\begin{matrix}Weighting coefficient for peak position = \frac{1}{\vert {Φ}_{1 , 2} ( ω ) \vert} \\ Weighting coefficient for position other than peak position = \frac{1}{\vert {Φ}_{1 , 2} ( ω ) \vert + C} or\end{matrix} \qquad ( Equation 12 )$$

$$\begin{matrix}Weighting coefficient for position other than peak position = \frac{1}{\vert {Φ}_{1 , 2} ( ω ) \vert + C} or \\ Weighting coefficient for position other than peak position = \frac{sfm \times A}{\vert {Φ}_{1 , 2} ( ω ) \vert} or\end{matrix} \qquad ( Equation 13 )$$

In this manner, in a case where sfm is less than Th (for example, in a case where the tonality is high), the cross spectrum is whitened at the peak position by the reciprocal of the amplitude of the cross spectrum.

Further, in a case where sfm is less than Th (for example, in a case where the tonality is high), the amplitude of the cross spectrum is reduced at positions other than the peak position compared to the peak position. For example, in a case where the weighting coefficient=(sfm×A)/|Φ_{1,2}(ω)|, the weighting coefficient is set to be smaller as sfm becomes lower, and the amplitude of the cross spectrum is reduced. Further, for example, in a case where the weighting coefficient=0, the amplitude of the cross spectrum is set to 0 regardless of the value of sfm.

As described above, by adaptively controlling the weighting coefficient based on the peak position of the cross spectrum, the cross spectrum is whitened at the peak position of the cross spectrum, and the component (for example, a frequency component with zero amplitude) in which the amplitude with respect to the peak of the cross spectrum is small is easily reduced at a position different from the peak position, and thus, the estimation accuracy of the ITD can be improved.

Note that, any one of the plurality of examples described above may be applied to the weighting coefficients of the cross spectra at other positions than the peak position, or the plurality of examples described above may be switched according to the size of the spectral peak or the size of the amplitude spectrum.

Further, threshold Th for sfm is not limited to a single threshold, and a plurality of thresholds may be set. Cross spectrum weighter 122 may apply any of the weighting coefficients described above, for example, in accordance with a comparison between sfm and a plurality of thresholds.

The above describes the modifications of Embodiment 2.

Note that, in Equation 3-2, (Th−sfm) may be used instead of (1−sfm). Here, Th represents a threshold for sfm. For example, Th may be set to a value in the range of 0<Th≤1. As an example, Th may be set to 0.2.

Further, for example, the term of (Th−sfm) may be represented by σ=γ−ε×sfm. For example, in the case of γ=1 and ε=1, σ is represented by 1−sfm, which is the same as in Equation 3-2. Further, for example, in a case where γ=Th and ε=1, σ is represented by Th−sfm.

Further, for example, in a case where (γ−ε×sfm) is 0 or less (for example, in a case where ε×sfm≥γ), σ may be set to 0. For example, in a case where γ=Th=0.2 and ε=1, (Th−sfm) is 0 or less, that is, in a case where sfm≥0.2, σ is set to 0. Thus, in a case where sfm≥0.2, weighting coefficient AdpWg is set to the reciprocal of amplitude |Φ_{1,2}(ω)| of the cross spectrum as in Equation 1-2. On the other hand, in a case where sfm<0.2, weighting coefficient AdpWg is set to a value according to weight control coefficient C (for example, the maximum amplitude of the cross spectrum).

As described above, by using σ=γ−ε×sfm, it is possible to appropriately set weighting coefficient AdpWg without switching the calculation formula of weighting coefficient AdpWg by comparing sfm and Th as described above.

For example, γ and ε may be set according to sfm. For example, γ and ε may be used as coefficients for controlling to what extent the weighting (for example, weighting coefficient) for a component with a small amplitude is set to be small. For example, the larger γ is, the higher the influence of weight control coefficient C on the setting of weighting coefficient AdpWg is, and the easier it is to reduce the weighting for components with small amplitudes. Further, for example, the smaller & is, the higher the influence of weight control coefficient C on setting of weighting coefficient AdpWg is, and the easier it is to reduce the weighting for components with a small amplitude.

Note that at least one of γ and ε is not limited to the value described above and may be another value. Further, at least one of γ and ε may be a fixed value or a variable value. The embodiments of the present disclosure have been each described, thus far.

Note that, in the above embodiment, the setting of weight control coefficient C

according to the maximum amplitude of the cross spectrum has been described, but the parameter used for the setting of weight control coefficient C is not limited to the maximum amplitude of the cross spectrum. For example, weight control coefficient C may be set according to at least one of the maximum amplitude, the average value, and the minimum amplitude of the cross spectrum amplitude. Alternatively, the parameter used for setting weight control coefficient C may be a fixed value that does not depend on the amplitude of the cross spectrum.

Further, in the above embodiment, the case where SFM is used as a parameter for determining whether a large number of frequency components with zero amplitude are included in the stereo signal (for example, whether the frequency component has a tonality or periodicity) has been described, but the present invention is not limited thereto, and another parameter may be used.

Various embodiments have been described with reference to the drawings hereinabove. Obviously, the present disclosure is not limited to these examples. Further, any combination of features of the above-mentioned embodiments may be made.

Further, any component with a suffix, such as “-er,” “-or,” or “-ar” in the above-described embodiments may be replaced with other terms such as “circuit (circuitry),” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless Local Area Network (LAN) system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A signal processing apparatus according to one exemplary embodiment of the present disclosure, includes: control circuitry, which, in operation, alters a weighting coefficient in accordance with a parameter related to a stereo signal, the weighting coefficient being based on an amplitude of a cross spectrum of the stereo signal: and detection circuitry, which, in operation, detects an inter-channel time difference of the stereo signal based on the cross spectrum weighted with the weighting coefficient.

In one exemplary embodiment of the present disclosure, the parameter includes a maximum value of the amplitude of the cross spectrum: and the control circuitry sets the weighting coefficient based on the maximum value.

In one exemplary embodiment of the present disclosure, the parameter includes a spectral flatness measurement of the stereo signal: and the control circuitry sets the weighting coefficient smaller as the spectral flatness measurement is lower.

In one exemplary embodiment of the present disclosure, the parameter includes a spectral flatness measurement of the stereo signal; and the control circuitry sets a first weighting coefficient in a case where the spectral flatness measurement is equal to or larger than a threshold, and sets a second weighting coefficient in a case where the spectral flatness measurement is smaller than the threshold, the second weighting coefficient being smaller than the first weighting coefficient.

In one exemplary embodiment of the present disclosure, the control circuitry sets the weighting coefficient for each component of the cross spectrum according to a value representing a difference between an amplitude value of the component and a maximum value of the amplitude of the cross spectrum.

In one exemplary embodiment of the present disclosure, the value representing the difference is a difference in a number of digits between the amplitude value of the component and the maximum value; and the control circuitry sets the weighting coefficient for the component smaller as the difference in the number of digits is larger.

In one exemplary embodiment of the present disclosure, the control circuitry detects a peak position of the cross spectrum, sets a first weighting coefficient for the peak position, and sets a second weighting coefficient smaller than the first weighting coefficient for a position different from the peak position.

In one exemplary embodiment of the present disclosure, the parameter includes a spectral flatness measurement of the stereo signal; and the control circuitry sets the second weighting coefficient based on the spectral flatness measurement.

In a signal processing method according to one exemplary embodiment of the present disclosure, a signal processing apparatus alters a weighting coefficient in accordance with a parameter related to a stereo signal, the weighting coefficient being based on an amplitude of a cross spectrum of the stereo signal; and detects an inter-channel time difference of the stereo signal based on the cross spectrum weighted with the weighting coefficient.

The disclosure of Japanese Patent Application No. 2022-142899, filed on Sep. 8, 2022, including the specification, drawings and abstract, is incorporated herein by reference in its entirety.

### Industrial Applicability

An exemplary embodiment of the present disclosure is useful for encoding systems and the like.

### Reference Signs List

10 Encoding apparatus
11 Input
12 A/D converter
13, 13a, 13b ITD analysis encoder
14, 24 Time difference adjuster
15 Stereo encoder
16 Multiplexer
20 Decoding apparatus
21 Separator
22 ITD decoder
23 Stereo decoder
25 D/A converter
26 Output
101 FFT section
102 Cross spectrum calculator
103 Amplitude calculator
104, 112, 122 Cross spectrum weighter
105 IFFT section
106 ITD detector
111 Maximum amplitude detector
121 SFM calculator

1. A signal processing apparatus, comprising:
control circuitry, which, in operation, alters a weighting coefficient in accordance with a parameter related to a stereo signal, the weighting coefficient being based on an amplitude of a cross spectrum of the stereo signal; and
detection circuitry, which, in operation, detects an inter-channel time difference of the stereo signal based on the cross spectrum weighted with the weighting coefficient.

2. The signal processing apparatus according to claim 1, wherein:
the parameter includes a maximum value of the amplitude of the cross spectrum: and
the control circuitry sets the weighting coefficient based on the maximum value.

3. The signal processing apparatus according to claim 2, wherein:
the parameter includes a spectral flatness measurement of the stereo signal, and
the control circuitry sets the weighting coefficient smaller as the spectral flatness measurement is lower.

4. The signal processing apparatus according to claim 2, wherein:
the parameter includes a spectral flatness measurement of the stereo signal, and
the control circuitry sets a first weighting coefficient in a case where the spectral flatness measurement is equal to or larger than a threshold, and sets a second weighting coefficient in a case where the spectral flatness measurement is smaller than the threshold, the second weighting coefficient being smaller than the first weighting coefficient.

5. The signal processing apparatus according to claim 1, wherein
the control circuitry sets the weighting coefficient for each component of the cross spectrum according to a value representing a difference between an amplitude value of the component and a maximum value of the amplitude of the cross spectrum.

6. The signal processing apparatus according to claim 5, wherein:
the value representing the difference is a difference in a number of digits between the amplitude value of the component and the maximum value, and
the control circuitry sets the weighting coefficient for the component smaller as the difference in the number of digits is larger.

7. The signal processing apparatus according to claim 1, wherein
the control circuitry detects a peak position of the cross spectrum, sets a first weighting coefficient for the peak position, and sets a second weighting coefficient smaller than the first weighting coefficient for a position different from the peak position.

8. The signal processing apparatus according to claim 7, wherein:
the parameter includes a spectral flatness measurement of the stereo signal, and
the control circuitry sets the second weighting coefficient based on the spectral flatness measurement.

9. A signal processing method performed by a signal processing apparatus, the signal processing method comprising:
altering a weighting coefficient in accordance with a parameter related to a stereo signal, the weighting coefficient being based on an amplitude of a cross spectrum of the stereo signal; and
detecting an inter-channel time difference of the stereo signal based on the cross spectrum weighted with the weighting coefficient.
